(19) United States
(12) Patent Application Publication
(10) Pub. No.: US 2008/0228508 A1
(43) Pub. Date: Sep. 18, 2008

(54) Monitoring connect time and time of operation of a solid state lighting device

(75) Inventors: Steve S. Lyons, Herndon, VA (US); Michael E. Garbus, Reston, VA (US); Matthew H. Aldrich, Arlington, VA (US); Alan W. Geishecker, Woodbridge, VA (US)

Correspondence Address: MCDERMOTT WILL & EMERY LLP, 600 13TH STREET, N.W., WASHINGTON, DC, 20005-3096, US

(73) Assignee: RENAISSANCE LIGHTING, INC.

(21) Appl. No.: 11/717,074

(22) Filed: Mar. 13, 2007

(51) Int. Cl. G06Q 90/00

(52) U.S. Cl. 705/1; 257/798

(57) ABSTRACT

Techniques are disclosed to monitor the time of operation of a solid state lighting system, e.g. for warranty purposes. Examples are disclosed that measure time of system connection to power and/or time of light output from the solid state emitter(s) of the system. A service under the warranty is provided if operation time does not exceed the warranty eligibility criteria, e.g. maximum limit(s). The service provided under the warranty may be pro-rated based on the time of operation.

### TECHNICAL FIELD

The teachings herein relate to techniques to monitor the operation of a lighting system that uses solid state light sources and to warranty programs for such systems based on measured time of operation, such as time of connection to power and/or time of light output.

### BACKGROUND

Many lighting technologies compete in the market based at least in part on longevity, that is to say expected performance lifetime. Light bulbs often are rated in terms of power (Watts), light output (lumens) and estimated hours of operation. One of the advantages of emerging solid state lighting (SSL) technologies over the more traditional light sources is the increased projected lifetime. In a laboratory or the like, it is possible to run a light or a number of competing lights and measure time until failure. However, in actual usage, there has been no commercially available way to monitor the actual time of operation, particularly with regard to lighting systems that utilize SSL light sources.

Examples of advanced systems for lighting applications, utilizing solid state light (SSL) sources, may be found in US patent application publication nos. 2006/0203483, 2006/0086897, 2006/0081773, 2006/0072314, 2005/0161586 and 2005/0161586.

Manufacturers often offer a warranty on their products, in some cases, including SSL lighting fixtures. A warranty for example might provide a replacement or repair if there is a failure or defect in the SSL light fixture within two years. However, such a warranty usually must run from a date certain, such as a date of shipment from the manufacturer or a date of sale by a retailer. In the case of architectural lighting fixtures, the device may not be installed and begin operation for some period after the sale, that is to say until the electrician installs the light and the building is sufficiently complete for actual use to begin. In such a case, some of the two year warranty period has already passed before initial operation.

Also, with the warranty from date of sale, the SSL light fixture may experience relatively little use during the remaining warranty period. Although the life of the fixture may be rated/projected in terms of one or more thousands of hours, the fixture may only experience tens or a few hundreds of hours of use before the time period for the warranty expires.

There have been proposals in the literature to monitor hours of operation, however, they have not fully addressed issues related to lighting systems that utilize SSL light sources. U.S. Pat. No. 4,980,900 to Welton, for example, suggested using an hour meter in a lighting system for a tanning studio, to evaluate performance of each lamp and control system and schedule maintenance. The patent does not address issues that are unique to SSL systems, because the lamps used were not SSL type light sources. Also, the monitoring for maintenance purposes does not teach use of the hour meter to determine operation time when there is a system failure, e.g. for warranty purposes or the like.

U.S. Pat. No. 6,483,247 to Edwards et al. discloses a technique of tracking operation time and temperature of a lamp. Although LEDs are used as indicators, the actual lamps monitored are not SSL type light sources. Examples of the monitored lamps include incandescent lamps, halogen lamps and other bulb and filament type sources. An indication may be provided when the light source has been operated for more than a set time. In at least some examples, the controller controls operation of the source in response to the operation time and temperature. This patent also indicates that the control of the light source based on age can alert the user to an impending failure of the light source. In this way, the user may order a new illuminator for delivery just before the time when the bulb fails. Again, the light sources used were not SSL type light sources, and the patent does not teach use of the hour meter to determine operation time to an actual system failure for warranty purposes or the like.

U.S. Pat. No. 6,333,602 to Kayser discloses a light source with an associated element to store sensed source operating parameters, such as operating time and temperature conditions. Purportedly, the data tracking was intended to help a manufacturer respond to a customer's claims for a free replacement or other consideration on the basis that the light source failed to perform within specified parameters for its guaranteed lifespan. The disclosed technique utilized a sensor for sensing operational parameters of the specific light source, and a data storage device integrated with the light source, for storing operating data correlated to the operational parameters of the light source. The light source in this patent may be a light bulb, an LED or an LED array. The patent teaches mounting the data storage device directly on the light source, e.g. directly on the package of the LED or an LED array, so that the data storage device is integral with the source. The light source was a replaceable device, hence, the data storage device would be replaced with the light source. As a result, data contained in the storage device related specifically to the light source itself, not to the overall system. The data associated with a source might indicate time to source failure. However, a lighting system may fail for other reasons. Since the light sources were interchangeable/replaceable, upon a system failure, there would be no way to determine the total time of operation of the system, as opposed to the individual times of operation of the various one or more light sources that may have been used in the system.

A need exists for techniques and systems improvements to determine one or more relevant time of operation parameters of a lighting system of a type that utilizes solid state light sources, such as LEDs, which will provide enhanced usage information for warranty purposes or the like.

### SUMMARY

Techniques and equipment are proposed herein to automatically monitor the actual time of operation of a solid state lighting system, as a whole. Also, warranties are provided for a solid state lighting system, based on such monitoring.

Hence, a method disclosed herein might involve offering a warranty for a solid state lighting system, based on time of system operation, with the sale of the solid state lighting system. Following installation of the solid state lighting system, a parameter of system operation is detected, and in response to that detected parameter, the methodology entails accumulating a measurement of total time of system operation from installation. Upon occurrence of a failure of the solid state lighting system, a determination is made whether or not the accumulated measurement of time of system operation meets a warranty eligibility criteria. A service offered under the warranty is provided with respect to the solid state lighting system, upon determining that the accumulated measurement of time of system operation meets the warranty eligibility criteria.

For example, warranty eligibility may be based on actual hours of operation. The monitor functionality records time of operation, and if a failure of the warranted solid state lighting system product occurs before the product has been operated for more hours than given in the warranty, then a warranty service for the failed product is provided, e.g. repair or replacement. In such a warranty example, if the solid state lighting system is operated more than the number of hours given in the warranty, then no action under the warranty is required at the time of the failure. If service or repair/replacement is available, it may also be pro-rated based on the time of operation until the failure.

Implementations of the lighting systems are also disclosed that monitor the system operation time or age in combination with the time that the system light emitters are operational. The system age, for example, may be measured on the basis of time that the system is connected to power, e.g. from time of installation in an architectural lighting application or the like. The time of operation of the light emitters, for example, may be measured based on time that power is applied to the emitters or on time that the emitters output measurable like, e.g. as might be detected by a light sensor.

Hence, an example of such a warranty method for the solid state lighting system might involve offering a warranty for the solid state lighting system, based on time of connection to power and operation time of a solid state emitter of the system, with sale of the solid state lighting system. Total time is measured, both for time of connection of the system to power and for time of operation of the system to generate light from the solid state emitter. Upon occurrence of a failure of the solid state lighting system, a determination is made whether or not at least one of the measured times meet warranty eligibility criteria. If so, then a service offered under the warranty is provided with respect to the solid state lighting system.

Where the monitoring tracks system operation time or age in combination with the time that the system light emitters are operational, a warranty may be based on either or both time measures. For example, if the warranty is based on time of operation of the solid state light emitters, the system age may still be useful in analyzing faults. Often, eligibility under the warranty depends on both time measurements. Hence, it is also possible to offer a split warranty of one period of operation for the solid state light emitters and a different period for other system components. Another approach would be to offer a combined time warranty, e.g. X hours of light output or Y hours (years) of system age. If eligible, the service provided may be pro-rated based on one of the time measurements.

The disclosure herein also teaches methods and equipment for monitoring a solid state lighting system and/or systems incorporating such monitoring equipment. Such methods and equipment may support warranties, as outlined above, or they may find other applications with regard to manufacture, sale and operation of solid state lighting systems.

Hence, an exemplary method of measuring age and operation time of a solid state lighting system from time of installation of the solid state lighting system might involve detecting connection of the system to power, and in response, measuring cumulative time of connection to power for the solid state lighting system as a representation of age of the system. The method may also entail monitoring operation of the solid state lighting system, to detect whenever at least one solid state light emitter of the system is operating so as to emit light; and based on that monitoring, measuring cumulative time of operation of the at least one solid state light emitter of the system. The measured cumulative time of connection to power and the measured cumulative time of operation of the at least one solid state light emitter of the system are both stored.

An exemplary solid state lighting system as discussed herein might include at least one solid state light emitter and a controller for connection to power, for applying a controlled drive signal to operate the solid state light emitter. The lighting system also includes means for detecting connection of the controller to power, and in response, measuring a cumulative time of connection to power; and for detecting operation of the at least one solid state light emitter to output light, and in response, measuring a cumulative operation time of light output of the at least one solid state light emitter.

In the specific examples disclosed, the solid state lighting system uses diffuse processing of the light generated by the at least one solid state light emitter to effectively convert the one or more emitters into a virtual source. Typically, for this purposes, the system includes an optical integrating cavity coupled to receive light from the solid state light emitter(s). The optical integrating cavity has a reflective interior surface, at least a portion of which exhibits at least substantially diffuse reflectivity with regard to the light from the emitter(s). The system also includes an optical aperture, which allows emission of reflected light from the optical integrating cavity.

Additional objects, advantages and novel features of the examples will be set forth in part in the description which follows, and in part will become apparent to those skilled in the art upon examination of the following and the accompanying drawings or may be learned by production or operation of the examples. The advantages of the present teachings may be realized and attained by practice of various aspects of the methodologies, instrumentalities and combinations set forth in the detailed examples discussed below.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a functional block diagram of a lighting system implementing a time of operation monitor.

FIG. 2 is a flow chart of a warranty program for a lighting system, wherein the period of warranty is based on measurement of the actual time of operation of the lighting system.

FIG. 3 is a functional block diagram of a lighting system implementing time monitoring, both for system operation time (‘age’) and light operation time.

FIG. 4 is a flow chart of a warranty program for a lighting system, wherein the warranty is based on measurement of the system operation time (age) and the light operation time of the lighting system.

FIG. 5A illustrates an example of light emitting system including a fixture using a solid state light emitting element, with certain elements of the fixture shown in cross-section.

FIG. 5B illustrates another example of a light emitting system using a plurality of solid state light emitting elements and a feedback sensor, with certain elements of the fixture shown in cross-section.

FIG. 5C illustrates another example of a light emitting system using white light type solid state light emitting elements of different color temperatures, with certain elements of the fixture shown in cross-section.

FIG. 5D illustrates another example of a light emitting system, using white type solid state light emitting elements of substantially the same color temperature, with certain elements of the fixture shown in cross-section.

FIG. 5E illustrates an example of a light emitting system in which one of the solid state light emitting elements emits ultraviolet (UV) light.

FIG. 5F illustrates an example of a light emitting system in which one of the solid state light emitting elements emits infrared (IR) light.

FIG. 6 illustrates an example of a solid state type light emitting system that may be the subject of the operation time monitoring, using primary color LEDs, wherein certain elements of the light fixture are shown in cross-section.

FIG. 7 is a functional block diagram of the electrical components, of one of the solid state lighting systems, using programmable digital control logic which may also implement the measurement of operation time of the lighting system.

### DETAILED DESCRIPTION OF EXAMPLES

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present concepts. Reference now is made in detail to the examples illustrated in the accompanying drawings and discussed below.

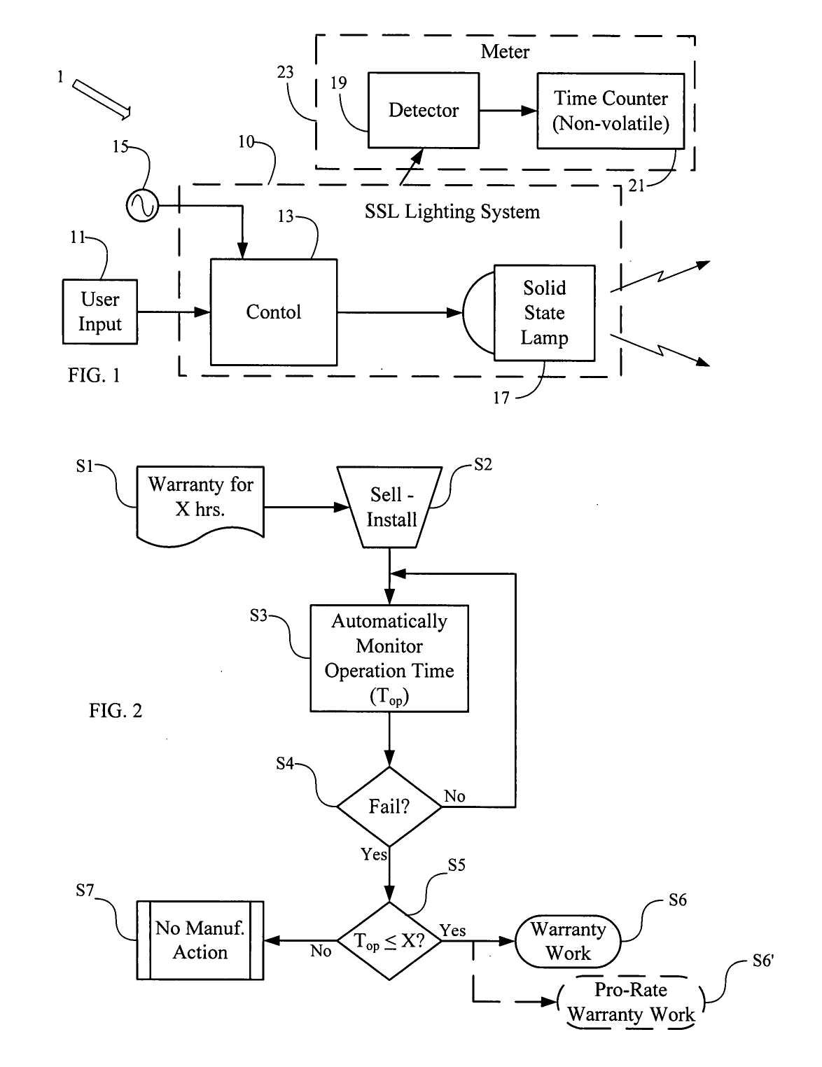

As shown in FIG. 1, a system 1 includes a “lighting system” 10, a user input mechanism 11 and elements to determine one or more parameters relating to time of actual operation of the lighting system 10 and/or elements thereof. The lighting system 10 includes a control 13 and a solid state lamp 17. The lamp 17 is a device, e.g. light fixture or the like, that uses one or more solid state light emitting elements to generate the light output of the lamp 17. As discussed more later, system 1 includes a detector 19 and a non-volatile time counter 21. The detector 19 and non-volatile time counter 21 function as a meter 23 for monitoring one or more time parameters related to actual operation of the lighting system 10.

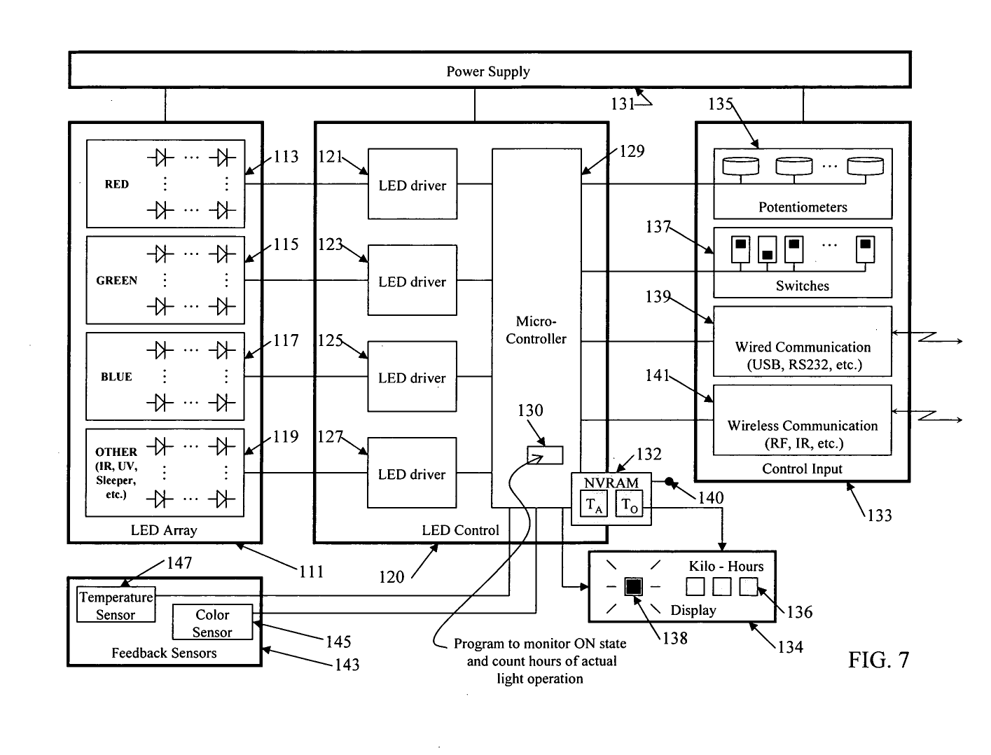

In response to a user input (or other control input signal) the control 13 controls application of power from a power source 15 to the solid state lamp 17. The user input mechanism 11 may be as simple as a button or a rotary dial, and the control 13 may be as simple as a switch for turning on the power to the solid state lamp 17 to activate one or more solid state light (SSL) emitting elements on the lamp 17 to emit light. Of course, the user input and control may take many other forms, and examples using digital logic are discussed below with regard to FIG. 7. Although the concept of monitoring one or more operation time parameters is applicable to systems actuated by automatic control, the present discussion of FIG. 1 assumes a simple example in which the user turns the lighting system 10 ON and OFF by actuation of the control 13 through input mechanism 11.

When ON, power flows to the solid state lamp 17 and the SSL emitter(s) of the lamp emit light. The detector 19 senses at least one state of the system related to time of operation. This may involve detecting time that the lighting system 10 is installed and ready for operation (connected to power). The detector may detect flow of power from the source 15 through the control 13, a state of the control 13, actual application of power (e.g. above a threshold amount) to the solid state lamp 17, light output from the lamp 17, or any other condition of the system 10 that provides an indication when the system 10 is actually ON and operating.

In the simple example, the detector 19 is a separate circuit element, for example, as might respond to voltage or current from the source 15 and/or applied to the lamp 17 and detect relevant state of the system 10. Of course other hardware and/or software may be used to implement the monitoring of operation time. For example, some or all of the monitoring may be implemented in the system control 13.

The time counter 21 runs in response to the appropriate system state, when detected by the detector 19. The counter may be implemented using an oscillator as a clock, a divider to divide the clock signal down to a frequency or rate corresponding to desired time units, and a counter with non-volatile storage that counts in response to the divided clock signal. The counter may be configured to count up the amount of usage or operation time. Alternatively, the counter may start at a predetermined value, say the usage limit of a warranty, and count down from the starting value. For purposes of a warranty based on expected performance lifetime expressed in hours, it may be convenient to count (or count down) actual operation time in units of hours or in some number of hours such as thousands (kilo) of hours; although obviously other units of time may be used.

FIG. 2 is a flow chart of a warranty method, as might be applied as a usage based warranty for a solid state lighting system, such as the system 10 of FIG. 1. In step S1, a manufacturer or seller offers a warranty with the sale of the lighting system 10. In the example, the warranty provides a promise of service, repair, replacement or the like in the event of a failure on or before some number X of hours of operation of the lamp 17 (ON state) of the system 10. For example, the manufacturer might offer a 30,000 hour warranty period, in which case X=30,000 hours. As noted, other time of operation parameters may be measured, e.g. time that system is operationally connected to a power source, such as AC line voltage.

In step S2, the manufacturer or downstream distributor sells the lighting system 10 to a customer who installs the lighting system. The system 10, for example, may be built into a building or architectural structure, or the system may be plugged into a simple wall outlet. The system 10 may be an element of another structure for a particular lighting or luminance application, for example, part of a sign or product display. Until installed and activated, there is no usage. So, the warranty is not compromised by such delay. In the example of FIG. 2, once the system 10 has been installed, the detector 19 senses whenever the system 10 is ON (to emit light), which enables the time counter 21 to automatically monitor operation time (step S3).

For purposes of this example, assume that the counter 21 accumulates or counts upward for all hours that the system 10 is ON. In the notation of the drawing, the automatic monitoring of ON time in step S3 produces a cumulative or total running operation time value Tₒₚ in the counter 21. As long as there is no failure or other similar warranty related issue, the monitoring continues (loop back through S4 to S3).

Assume now for discussion purposes that there is a failure (the process branches from S4 to S5). In a typical scenario, the end user might return the lighting system 10 to the retailer or manufacturer if the system is easily removable/portable, or the user might call a service representative to come out to the location to check the system 10 if the system is permanently installed.

As part of the warranty program, it is now possible to check the operation time parameter, in the example, accumulated actual time of operation Tₒₚ with regard to warranty criteria. In the example, the actual time of operation Tₒₚ is checked against the warranty threshold X of eligibility (decision in step S5), to determine if the warranty applies. If the actual usage is equal to or less than the maximum warranty threshold (Tₒₚ≦X), then the manufacture will provide appropriate response in accord with the warranty (step S6), for example by repairing or replacing the defective system or components thereof. As an alternative shown in dotted line form (S6′), the warranty service provided may be pro-rated based on time of operation (e.g. if the time exceeds some minimum threshold but does not exceed the maximum warranty threshold).

If the actual usage is greater than the warranty threshold (Tₒₚ>X), then the manufacture would not need to take any action under the warranty (step S7). In the 30,000 hour example, the manufacturer could provide warranty service in the event of a failure before actual operation time (accumulated lamp ON state time) of the system 10 exceeds 30,000 hours. As another example, the manufacturer might provide a full replacement if failure occurs before 10,000 hours and pro-rated service or replacement in the event of a failure between 10,000 and 30,000 hours. However, it would be the user's responsibility to pay to fix the system 10 or purchase a replacement if the system fails after 30,000 hours of operation.

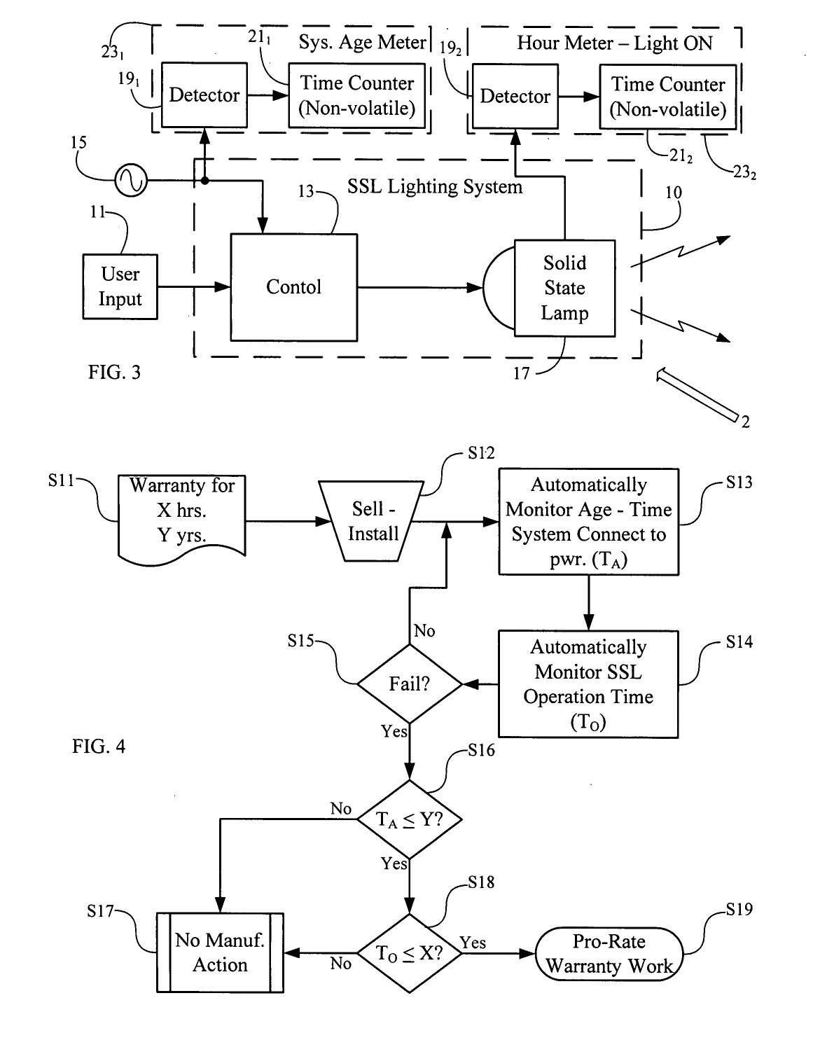

The example of FIG. 2 related to a warranty based on a single operational time parameter, time of lamp operation (Tₒₚ). It is envisaged that the time monitoring functions may involve monitoring of two or more relevant time parameters, one or more of which may be used for warranty purposes. Hence, FIG. 3 shows a system 2 that includes two time metering devices 23₁ and 23₂. The system 2 includes a lighting system 10 similar to that in FIG. 1, and similar elements are identified by similar reference numbers. The meter 23₁ includes a detector 19₁ and a non-volatile time counter 19₁, configured to measure system age from installation, in terms of time connected to power source 15. The meter 23₂ includes a detector 19₂ and a non-volatile time counter 19₂, configured to measure to of actual operation of the solid state lamp 17 to output light.

The detector 19₁ is responsive to the ability of the system to operate. Typically, the detector 19₁ is a circuit or function of the control circuit 13 to detect when power is available to the system 10. The function of detector 19₁ may involve a current and/or voltage detection function on the power rail of the system 10. In this way, the detector 19₁ determines when the system 10 is first installed so as to be operational and provides a detection of the ability to operate so long as power is available. However, there would be no detection prior to installation and/or for periods when power is completed removed.

The counter 21₁ operates much like the counter 21 in the example of FIG. 1, except that it is responsive to the particular state detection by the detector 19₁. As in the earlier discussion, the counter 21₁ may count up or down for the time that there is an appropriate detection by the detector 19₁, in units that are appropriate for the particular warranty or service life analysis.

The detector 19₂ is responsive a state of the lamp 17 corresponding to light output. Various different strategies may be used to detect such actual operation of the one or more emitters of the solid state lamp 17. One strategy is to detect application of a drive signal (current and/or voltage) from the control 13 to the solid state lamp 17. Depending on the type of control circuit, the detector may sense when the drive signal meets or exceeds a threshold expected to correspond to minimum light out by the solid state lamp 17. Another approach is for the control 13 to detect a state when it turns the lamp 17 ON. Yet another strategy might involve detection of light output the solid state lamp 17, e.g. using a light sensor. Several of these strategies are discussed in later examples. In each case, however, the element performing the function of the detector 19₂ will provide an indication to the counter 23₂ when it detects that the lamp 17 is operating in a manner that actually produces (or is expected to produce) light output.

For example, the detector 23₂ will not provide any detection indication before the system 10 is initially installed or turned-ON. Similarly, there will be no indication from the detector 23₂ during periods when the system 10 is OFF, and the lamp 17 is not generating any light output, even if power from source 15 is available to the control 13.

The counter 21₂ operates much like the counter 21 in the example of FIG. 1, except that it is responsive to the particular state detection by the detector 19₂. Hence, the non-volatile time counter 21₂ operates to count up or count down for the time that there is an appropriate detection by the detector 19₁ indicating a light output condition of the solid state lamp 17, in units that are appropriate for the particular warranty or service life analysis. The counter 21₁ might count days or years of system connect time (system ‘age’ in the drawing), whereas the counter 21₂ might count hours or thousands of hours related to light generation by the emitter(s) of the SSL lamp 17.

FIG. 4 is a flow chart of a warranty method, as might be applied as a usage based warranty for a solid state lighting system, such as the system 10 using the meters 23₁ and 23₂ as shown in of FIG. 3. In step S11, a manufacturer or seller offers a warranty with the sale of the lighting system 10. Here, eligibility is based on one or the other or both of the two time measurements. For this example, assume eligibility depends on both connect time and lamp operation time. Hence, the warranty provides a promise of service, repair, replacement or the like in the event of a failure on or before some number X of hours of operation of the emitter(s) of the lamp 17 (ON state) of the system 10. In this example, the warranty also includes a limitation of Y years based on the system connect time (system ‘age’ in the drawing). For example, the manufacturer might offer a 7 year—50,000 hour warranty period, in which case Y=7 years and X=50,000 hours.

In step S12, the manufacturer or downstream distributor sells the lighting system 10 to a customer who installs the light system. Again, the system 10 may be built into a building or architectural structure, or the system may be plugged into a simple wall outlet; or the system 10 may be an element of another structure for a particular lighting or luminance application, for example, part of a sign or product display. Until installed and activated, there is no connect time or output time measured by the meters 23₁ and 23₂. So, the warranty is not compromised by such delay.

For purposes of this example, assume that each of the counters accumulates or counts upward. In the example of FIG. 4, once the system 10 has been installed, the detector 19₁ senses whenever the system 10 is connected to power and available for operation, which enables the time counter 21₁ to automatically monitor system age (step S13). The accumulated age value is represented by T_{A} in the drawing. The detector 19₂ senses whenever the lamp 17 of the system 10 is ON (to emit light), which enables the time counter 21₂ to automatically monitor actual system/lamp operation time T_{O} (step S14). As long as there is no failure or other similar warranty related issue, the monitoring continues (loop back through S15 to S13).

Assume now for discussion purposes that there is a failure (the process branches from step S15 to step S16). In a typical scenario, the end user might return the lighting system 10 to the retailer or manufacturer if the system is easily removable/portable, or the user might call a service representative to come out to the location to check the system 10 if the system is permanently installed. In the subsequent steps, the system age and operation time can be checked against the warranty terms for eligibility and/or type or cost of service available under the warranty. The order of the steps does not matter. In the example, in step S16 the system age T_{A} is compared to the warranty criteria Y. If the system age T_{A} exceeds the warranty criteria Y (e.g. the system has been connected to power for more than 7 years in the above example), then processing branches to step S17 in which no manufacturer action is required under the warranty.

However, if the system age T_{A} is less than or equal to the warranty criteria Y (e.g. the system has not been connected to power for more than 7 years in the above example), then processing branches to step S18 in which the system operation time for light output T_{O} is checked against the hours of operation warranty criteria X (decision in step S18). If the actual usage time is greater than the warranty threshold (T_{O}>X), then the manufacture would not need to take any action under the warranty (step S17).

If the actual system operation time or usage is equal to or less than the maximum warranty threshold (T_{O}≦X), however, then the manufacture will provide appropriate response in accord with the warranty; and processing branches to step S19. In this example, the repair or replacement of the defective system 10 is provided on a basis pro-rated in accordance with one or more of the time measurements T_{A} or T_{O}. Typically, the manufacturer would replace the lighting system 10 at an expense reduced by an amount proportional to the operation time measurement T_{O}. In the 7 year—50,000 hour example, the manufacturer could provide a reduced cost replacement in the event of a failure before 7 years of connect time or before 50,000 hours of lamp operation, and the amount of the cost reduction would be inversely proportional to the number of hours of lamp operation (fewer hours, less cost to the customer; more hours more cost to the customer).

In the examples of FIGS. 1 to 4, the entire SSL system 10 is covered by the time-based warranty. The failure of the system 10 may be due to a failure of the control 13, the lamp 17 or some other necessary component of the system 10; and in the event of any failure, the decision(s) as to the warranty can be based on total time of system operation up to the time of that failure. As discussed later, a more comprehensive detection may also sense a performance condition and declare a failure when the system 10 no longer operates in accord with some acceptable standard, e.g. when the system 10 can no longer produce light of adequate intensity or spectral characteristic as promised by the system's specifications. From the customer perspective, the customer receives the promised warranty service/repair based on operation time to failure, regardless of the cause of the failure.

From the point of view of the manufacture and/or service company, the time monitoring may also help with analysis of failures. Upon failure under warranty, the defective system 10 can be analyzed to determine the component that caused the particular system failure. A solid state lighting system 10, for example, may fail because of a failure of a power supply element, an electronic component (e.g. microprocessor) of the controller, a solid state element in the lamp, etc. In some cases, the component manufacturer/supplier may also promote their products on the basis of expected performance life. Typically, the solid state light emitters forming lamp 17 will have one projected life, the microcontroller used in the control 13 will have another projected life, etc. Hence, the manufacturer system 10 can use the time data to go back to the component manufacturer/supplier for restitution with regard to the defective component.

The concepts outlined above may be applicable to any solid state lighting system 10 where it might be desirable to warrant the product based on projected performance life. Many solid state lighting systems utilize digital control circuitry, and the time monitoring functionality may be incorporated into the functions of the digital control circuitry of the SSL system itself. Also, it is envisaged that many applications of these teachings will involve solid state lamps that utilize an optical integrating cavity to process light from one or more solid state light emitters. To facilitate clear understanding of such applications, it may be helpful to consider several examples of solid state lighting systems and then an example with a digital control system, in somewhat more detail.

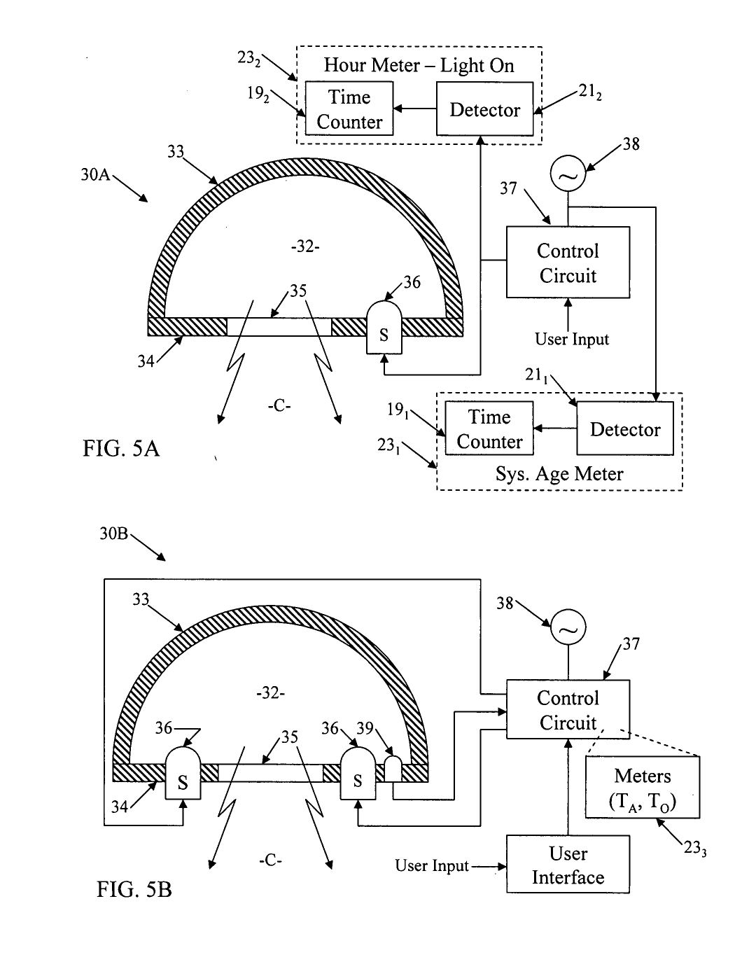

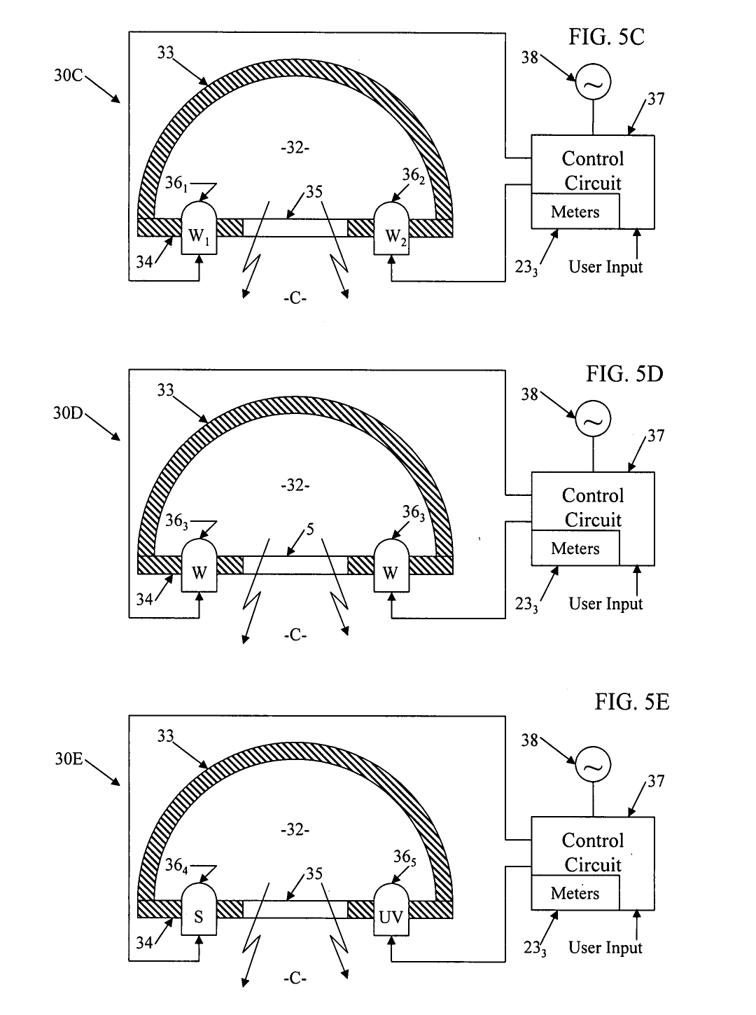

As shown in FIG. 5A, an exemplary lighting system 30A includes an optical integrating cavity 32 having a reflective interior surface. At least a portion of the interior surface of the cavity 32 exhibits a diffuse reflectivity. The cavity 32 may have various shapes. The illustrated cross-section would be substantially the same if the cavity is hemispherical or if the cavity is semi-cylindrical with a lateral cross-section taken perpendicular to the longitudinal axis. It is desirable that the cavity surface have a highly efficient reflective characteristic, e.g. a reflectivity equal to or greater than 90%, with respect to the relevant wavelengths. The entire interior surface may be diffusely reflective, or one or more substantial portions may be diffusely reflective while other portion(s) of the cavity surface may have different light responsive characteristics. In some examples, one or more other portions are substantially specular.

For purposes of the discussion, the cavity 32 in the system 30A is assumed to be hemispherical. In such an example, a hemispherical dome 33 and a substantially flat cover plate 34 form the optical cavity 32. At least the interior facing surface(s) of the dome 33 are highly diffusely reflective with respect to the radiant energy spectrum produced by the system 30A. The interior surface of the cover plate 34 is reflective, e.g., diffusely reflective or specular. The cavity 32 forms an integrating type optical cavity. Although shown as separate elements, the dome and plate may be formed as an integral unit. The cavity 32 has an optical aperture 35, which allows emission of reflected and diffused light C from within the interior of the cavity 32 into a region to facilitate a humanly perceptible lighting application for the system 30A.

The lighting system 30A also includes at least one source of radiant electromagnetic energy. Although other types of sources of radiant electromagnetic energy may be incorporated into the system for some applications, at least one source takes the form of a solid state light emitting element (S), represented by the single solid state lighting element (S) 36 in the drawing. In a single source example, the element (S) 36 typically emits visible light. In multi-source examples discussed later, some source(s) may emit visible light and one or more other sources may emit light in another part of the electromagnetic spectrum. Each solid state light emitting element (S) 36 is coupled to supply light to enter the cavity 32 at a point not directly observable through the aperture 35 from the region illuminated by the fixture output C. Hence, light from the element (S) 36 reflects one or more times within the cavity 32 before emission through the aperture 35. Various couplings and various light entry locations may be used. Processing of the light within the cavity 32 converts the one or more sources 36 into a virtual source at the aperture 35.

As discussed herein, applicable solid state light emitting elements (S) essentially include any of a wide range of light emitting or generating devices formed from organic or inorganic semiconductor materials. Examples of solid state light emitting elements include semiconductor laser devices and the like. Many common examples of solid state lighting elements, however, are classified as types of “light emitting diodes” or “LEDs.” This exemplary class of solid state light emitting devices encompasses any and all types of semiconductor diode devices that are capable of receiving an electrical signal and producing a responsive output of electromagnetic energy. Thus, the term “LED” should be understood to include light emitting diodes of all types, light emitting polymers, organic diodes, and the like. LEDs may be individually packaged, as in the illustrated examples. Of course, LED based devices may be used that include a plurality of LEDs within one package, for example, multi-die LEDs that contain separately controllable red (R), green (G) and blue (B) LEDs within one package. Those skilled in the art will recognize that “LED” terminology does not restrict the source to any particular type of package for the LED type source. Such terms encompass LED devices that may be packaged or non-packaged, chip on board LEDs, surface mount LEDs, and any other configuration of the semiconductor diode device that emits light. Solid state lighting elements may include one or more phosphors and/or nanophosphors based upon quantum dots, which are integrated into elements of the package or light processing elements of the fixture to convert at least some radiant energy to a different more desirable wavelength or range of wavelengths.

The color or spectral characteristic of light or other electromagnetic radiant energy relates to the frequency and wavelength of the radiant energy and/or to combinations of frequencies/wavelengths contained within the energy. Many of the examples relate to colors of light within the visible portion of the spectrum, although examples also are discussed that utilize or emit other energy. Electromagnetic energy, typically in the form of light energy from the one or more solid state light sources (S) 36, is diffusely reflected and combined within the cavity 32 to form combined light C for emission via the aperture 35. Such integration, for example, may combine light from multiple sources. The integration tends to form a relatively Lambertian distribution across the aperture. When viewed from the area illuminated by the combined light C, the aperture appears to have substantially infinite depth of the integrated light C. Also, the visible intensity is spread uniformly across the aperture, as opposed to individual small point sources of higher intensity as would be seen if the one or more elements (S) 36 were directly visible without diffuse reflection before emission through the aperture 35. To an observer outside the cavity 32, the aperture appears to be the light source. Or stated another way, the cavity 32 forms a virtual light source at the aperture 35.

Pixelation and color striation are problems with many prior solid state lighting devices that do not use a diffuser or the like sufficient to form a virtual source. When such a prior fixture output is observed, the light output from individual LEDs or the like appear as identifiable/individual point sources or ‘pixels.’ Even with diffusers or other forms of common mixing, the pixels of the sources are apparent. The observable output of such a prior system exhibits a high maximum-to-minimum intensity ratio. In systems using multiple light color sources, e.g. RGB LEDs, unless observed from a substantial distance from the fixture, the light from the fixture often exhibits striations or separation bands of different colors.

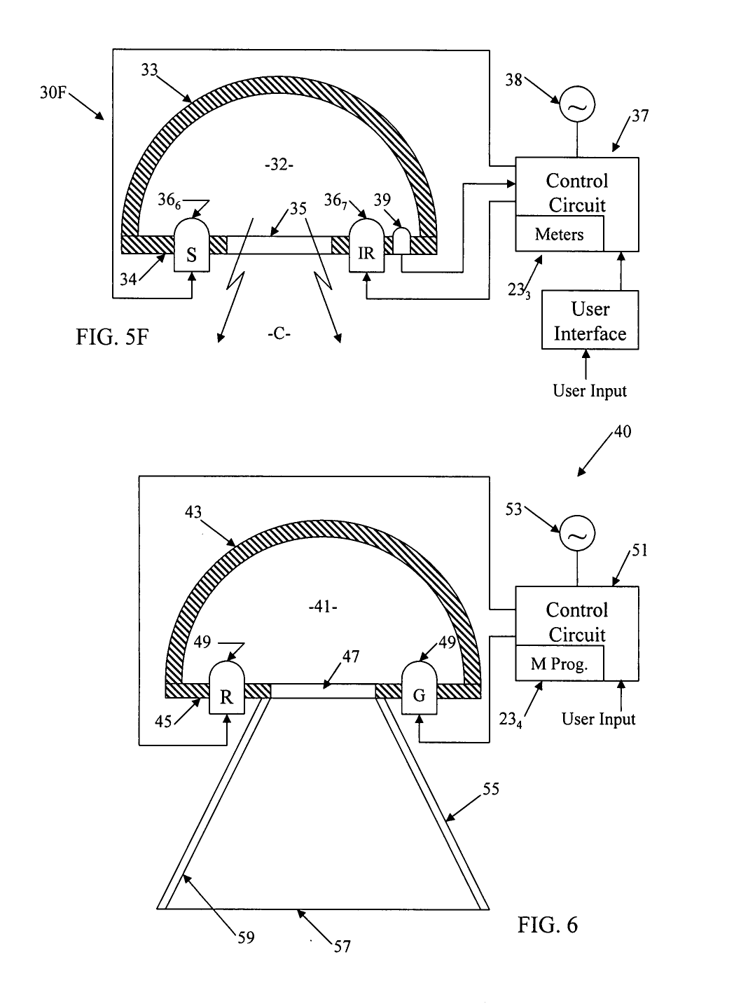

The more specific examples of systems and light fixtures as disclosed herein (FIGS. 5A-6), however, do not exhibit such pixilation. Instead, the cavity output C is unpixelated and relatively uniform across the apparent output area or virtual source of the fixture, e.g. across the optical aperture 35 of the cavity 32. The optical integration sufficiently mixes the light from the solid state light emitting elements 36 that the combined light output C is at least substantially Lambertian in distribution across the optical output area of the fixture, that is to say across the aperture 35 of the cavity 32. As a result, the combined light output C exhibits a relatively low maximum-to-minimum intensity ratio across the aperture 35. In such examples, the combined light output C exhibits a maximum to minimum ratio of 2 to 1 or less over substantially the entire optical output area. These examples rely on various implementations of the optical integrating cavity 32 as the mixing element to achieve this level of output uniformity, however, other mixing elements could be used if they are configured to produce such uniform output (Lambertian and/or relatively low maximum-to-minimum intensity ratio across the fixture's optical output area).

It also should be appreciated that solid state light emitting elements 36 may be configured to generate electromagnetic radiant energy having various bandwidths for a given spectrum (e.g. narrow bandwidth of a particular color, or broad bandwidth centered about a particular), and may use different configurations to achieve a given spectral characteristic. For example, one implementation of a white LED may utilize a number of dies within one package that generate different primary colors which combine to form essentially white light. In another implementation, a white LED may utilize a semiconductor that generates light of a relatively narrow first spectrum in response to an electrical input signal, but the narrow first spectrum acts as a pump. The light from the semiconductor “pumps” a phosphor material contained in the LED package, which in turn radiates a different typically broader spectrum of light that appears relatively white to the human observer.

The system 30A also includes a controller, shown in the example as a control circuit 37, which is responsive to a user actuation for controlling an amount of radiant electromagnetic energy supplied to the cavity 32 by the solid state light emitting element or elements 36 of the system 30A. The control circuit 37 typically includes a power supply circuit coupled to a power source, shown as an AC power source 38. The control circuit 37 also includes one or more adjustable driver circuits for controlling the power applied to the solid state light emitting elements (S) 36 and thus the amount of radiant energy supplied to the cavity 32 by each source 36. The control circuit 37 may be responsive to a number of different control input signals, for example, to one or more user inputs as shown by the arrow in FIG. 53 and possibly signals from one or more sensors. Specific examples of the control circuitry are discussed in more detail later.

In accord with the teachings discussed above with regard to FIGS. 1 to 4, the system 30A also includes at least a set of the meters 23₁ and 23₂. The system age meter 23₁ comprises a detector 19₁ configured to detect when the system 30A is connected to power source 38 and a counter 21₁ for counting system age or connect time, as in the example of FIG. 3. The hour meter 23₂ for measuring the light ON time comprises a detector 19₂ and a counter 21₂, as in the example of FIG. 3. Here, the detector 19₂ senses application of power from the source 38 and control circuit 37 to the solid state light emitting source (S) 36. In such an arrangement, the detector 19₂ might sense voltage or current applied to the solid state light source (S) 36, and the detector 19₂ detects an ON state when the current or voltage meets or exceeds a threshold corresponding to a sufficient power level to cause the solid state light source (S) 36 to emit light. The time counter 21₂ runs in response to the ON state, when detected by the detector 19₂, as outlined above. In this way, the data maintained in non-volatile storage by the counter 21₂ indicates the amount of time that the system 30A has actually been ON and operating to generate a light output.

The operation time data may be read from the counter 21 in any of a number of known ways. For example, a technician may use an appropriate tool to read the data from non-volatile storage in the event of a failure. Alternatively, one or both of the meters 23₁, 23₂ might further include a display (not shown) to provides a visible output of respective time data.

The meters 23₁, 23₂ may be at any convenient location. In many cases, the meters may be attached to or incorporated in the fixture that includes the cavity 32 and the solid state light source (S) 36. As another example, the meters may be located with the control circuit 37. Other locations are possible, including location with a user input device.

FIG. 5B shows another example of a lighting system, that is to say system 30B. The system 30B, for example, includes an optical integrating cavity 32 similar to that discussed above relative to FIG. 5A. Again, the cavity 32, formed in the example by the dome 33 and the cover plate 34, has a reflective interior. At least one surface of the interior of the cavity 32 is diffusely reflective, so that the cavity diffusely reflects light and thereby integrates or combines light. The cavity 32 has an optical aperture 35 for allowing emission of reflected light from within the interior of the cavity as combined light C directed into a region to facilitate a humanly perceptible lighting application for the system 30B.

In this type of exemplary system 30B, there are a number of solid state light emitting elements or sources (S) 36 for emitting light, similar to the element(s) 36 used in the system 30A of FIG. 5A. At least one of the solid state light emitting elements 36 emits visible light energy. The other emitting element 36 typically emits visible light energy, although in some case the other element may produce other spectrums, e.g. in the ultraviolet (UV) or infrared (IR) portions of the electromagnetic spectrum. Each of the solid state light emitting elements (S) 36 supplies light (visible, UV or IR) into the cavity 32 at a point not directly observable through the aperture 35 from the region so that the light reflects within the cavity before emerging through the aperture. Light from each source 36 diffusely reflects at least once inside the cavity 32 before emission as part of the combined light C that emerges through the aperture 32.

The system may also include a user interface device for providing the means for user input. The exemplary system 30B also includes a sensor 39 for detecting a characteristic of the reflected light from within the interior of the cavity 32. The sensor 39, for example, may detect intensity of the combined light in the cavity 32. As another example, the sensor may provide some indication of the spectral characteristic of the combined light in the cavity 32. The controller 37 is generally similar to that shown in FIG. 5A and discussed above. However, in this example, the controller 37 is responsive both to a user input of a selected desired light characteristic and to an indication of the characteristic of the reflected light from within the interior of the cavity 32 provided by the sensor 39. In response, the controller 37 controls the amount of light supplied to the cavity by each of the solid state light emitting elements 36. Detailed examples of the user interface, the sensor and the responsive control circuit are discussed below relative to FIG. 7.

Again, the system 30B includes means to monitor one or more parameters related to time of system operation. The system could include one or more separate meters as illustrated in the previous drawings, but in the example of FIG. 5B, the control circuit implements the functionalities 23₃ of the system age and time of operation meters. The functionality 23₃ within the control circuit 37 monitors system age (T_{A}) and time of lighting operation (T_{O}) as did the meters in the examples of FIGS. 3 and 5A. The meter functions 23₃ may be implemented in the control circuit by specific hardware elements or by programming of a microcontroller or other processor within the circuit 37 or by some combination of hardware and programming. A means to read out the data or a display may be provided. For example, the control circuit 37 may be configured to supply system age data (T_{A}) and total light operation time data (T_{O}) to the user interface, for reading whenever desired by the user.

Some systems that use multiple solid state light emitting elements (S) 36 may use sources 36 of the same type, that is to say a set of solid state light emitting sources that all produce electromagnetic energy of substantially the same spectral characteristic. All of the sources may be identical white light (W) emitting elements or may all emit light of the same primary color. The system 30C (FIG. 5C) includes multiple white solid state emitting (S) 36₁ and 36₂. Although the two white light emitting elements could emit the same color temperature of white light, in this example, the two elements 36 emit white light of two different color temperatures.

The system 30C is generally similar to the systems 30A and 30B discussed above, and similarly numbered elements have similar structures, arrangements and functions. However, in the system 30C the first solid state light emitting element 36₁ is a white LED W₁ of a first type, for emitting white light of a first color temperature, whereas the second solid state light emitting element 36₂ is a white LED W₂ of a second type, for emitting white light of a somewhat different second color temperature. Controlled combination of the two types of white light within the cavity 32 allows for some color adjustment, to achieve a color temperature of the combined light output C that is somewhere between the temperatures of the two white lights, depending on the amount of each white light provided by the two elements 36₁ and 36₂.

FIG. 5D illustrates another system example 30D. The system 30D is similar to the system 30C discussed above, and similarly numbered elements have similar structures, arrangements and functions. However, in the system 30D the multiple solid state light emitting elements 36₃ are white light emitters of the same type. Although the actual spectral output of the emitters 36₃ may vary somewhat from device to device, the solid state light emitting elements 36₃ are of a type intended to emit white light of substantially the same color temperature. The diffuse processing and combination of light from the solid state white light emitting elements 36₃ converts the multiple point sources 36 to a wider area virtual source at the aperture 35 and provides a uniform white light output over the area of the aperture 35, much like in the other embodiment of FIG. 5C. However, because the emitting elements 36₃ all emit white light of substantially the same color temperature, the combined light C also has substantially the same color temperature.

Although applicable to all of the embodiments, it may be helpful at this point to consider an advantage of the lamp or fixture geometry in a bit more detail, with regard to the white light examples, particularly that of FIG. 5D. Outputs of the solid state light emitting elements 36 represent point sources of light. The actual area of light emission from each element 36 is relatively small. Such a concentrated light output may be potentially hazardous if viewed directly. The processing within the cavity 32, however, spreads the light from the solid state light emitting elements 36 uniformly over the much larger area of the aperture 35. Although the aperture may still appear as a bright light source (virtual source), the bright light over a larger area will often represent a reduced hazard. The intensity at any point in the aperture will be much less than that observable at the point of emission of one of the solid state light emitting elements 36. Hence, the cavity 32 serves as an optical processing element to diffuse the light from the solid state light emitting element 36 over the optical output area represented by the aperture 35, to produce a virtual source having a light output through the optical output area (aperture 35) that is sufficiently uniform as to appear as an unpixelated light output.

FIGS. 5E and 5F illustrate additional system examples, which include at least one solid state light emitting element for emitting light outside the visible portion of the electromagnetic spectrum. The system 30E is similar to the systems discussed above, and similarly numbered elements have similar structures, arrangements and functions. In the system 30E, one solid state light emitting element 36₄ emits visible light, whereas another solid state light emitting element 36₅ emits ultraviolet (UV) light. The cavity 32 reflects, diffuses and combines visible and UV light from the solid state light emitting element 36₄ and 36₅, in essentially the same manner as in the earlier visible light examples.

The system 30F is similar to the systems discussed above, particularly the system 30B of FIG. SB, and similarly numbered elements have similar structures, arrangements and functions. In the system 30F, one solid state light emitting element 36₆ emits visible light, whereas another solid state light emitting element 36₇ emits infrared (IR) light. The cavity 32 reflects, diffuses and combines visible and IR light from the solid state light emitting element 36₆ and 36₇ in essentially the same manner as in the earlier examples. The sensor 39 in this example may detect visible light and/or IR light, depending of the needs of a particular application.

In the examples of FIGS. 5C to 5F, each system includes means to monitor time of system operation. As in the example of FIG. 5B, the control circuit 37 implements the functionality of the time meters 23₃. Again, the meters detect operation of the system and count both time of connection to power and the total time of lighting operation. The meter functions may be implemented in the control circuit by specific hardware elements or by programming of a microcontroller or the like within the circuit 37 or by some combination of hardware and programming.

Applications are also disclosed wherein the solid state lighting system utilizes sources of two, three or more different types of light sources, that is to say solid state light sources that produce electromagnetic energy of two, three or more different spectral characteristics. Many such examples include sources of visible red (R) light, visible green (G) light and visible blue (B) light or other combinations of primary colors of light. Controlled amounts of light from primary color sources can be combined to produce light of many other visible colors, including various temperatures of white light. It may be helpful now to consider several more detailed examples of lighting systems using solid state light emitting elements. A number of the examples, starting with that of FIG. 6 use RGB LEDs or similar sets of devices for emitting three or more colors of visible light for combination within the optical integrating cavity.

FIG. 6 includes a cross-sectional illustration of a radiant energy distribution apparatus or lamp of a solid state lighting system 40. For task lighting applications and the like, the apparatus emits light in the visible spectrum, although the system 40 may be used for luminance applications and/or with emissions in or extending into the infrared and/or ultraviolet portions of the radiant energy spectrum.

The illustrated system 40 includes an optical cavity 41 having a diffusely reflective interior surface, to receive and combine radiant energy of different colors/wavelengths. The cavity 41 may have various shapes. The illustrated cross-section would be substantially the same if the cavity is hemispherical or if the cavity is semi-cylindrical with the cross-section taken perpendicular to the longitudinal axis. The optical cavity in the examples discussed below is typically an optical integrating cavity.

The disclosed apparatus may use a variety of different structures or arrangements for the optical integrating cavity, examples of which are discussed in US patent application publication nos. 2006/0237636, 2006/0203483, 2006/0086897, 2006/0081773, 2006/0072314, 2005/0161586 and 2005/0156103. At least a substantial portion of the interior surface(s) of the cavity exhibit(s) diffuse reflectivity. It is desirable that the cavity surface have a highly efficient reflective characteristic, e.g. a reflectivity equal to or greater than 90%, with respect to the relevant wavelengths. In the example of FIG. 6, the surface is highly diffusely reflective to energy in the visible, near-infrared, and ultraviolet wavelengths.

The cavity 41 may be formed of a diffusely reflective plastic material, such as a polypropylene having a 97% reflectivity and a diffuse reflective characteristic. Such a highly reflective polypropylene is available from Ferro Corporation—Specialty Plastics Group, Filled and Reinforced Plastics Division, in Evansville, Ind. Another example of a material with a suitable reflectivity is SPECTRALON. Alternatively, the optical integrating cavity may comprise a rigid substrate having an interior surface, and a diffusely reflective coating layer formed on the interior surface of the substrate so as to provide the diffusely reflective interior surface of the optical integrating cavity. The coating layer, for example, might take the form of a flat-white paint or white powder coat. A suitable paint might include a zinc-oxide based pigment, consisting essentially of an uncalcined zinc oxide and preferably containing a small amount of a dispersing agent. The pigment is mixed with an alkali metal silicate vehicle-binder, which preferably is a potassium silicate, to form the coating material.

For purposes of the discussion, the cavity 41 in the apparatus 40 is assumed to be hemispherical. In the example, a hemispherical dome 43 and a substantially flat cover plate 45 form the optical cavity 41. At least the interior facing surface of the dome 43 is highly diffusely reflective and the interior facing surface of the cover plate 45 is reflective (e.g., diffusely reflective or specular), so that the resulting cavity 41 is highly diffusely reflective with respect to the radiant energy spectrum produced by the device 40. As a result, the cavity 41 is an integrating type optical cavity. Although shown as separate elements, the dome and plate may be formed as an integral unit. For example, rectangular cavities are discussed later in which the dome and plate are elements of a unitary extruded member.

The optical integrating cavity 41 has an aperture 47 for allowing emission of combined radiant energy. In the example, the aperture 47 is a passage through the approximate center of the cover plate 45, although the aperture may be at any other convenient location on the plate 45 or the dome 43. Because of the diffuse reflectivity within the cavity 41, light within the cavity is integrated or combined before passage out of the aperture 47.

The integration produces a highly uniform light distribution across the virtual light source formed at the aperture 47, that is to say at the output area of the cavity 41 that often forms all or a substantial part of the output area of the fixture. Typically, the distribution of light across the aperture 47 is substantially Lambertian. During operation, when viewed from the area illuminated by the combined light, the aperture 47 appears to have substantially infinite depth of the integrated color of light. Also, the visible intensity is spread uniformly across the aperture 47, as opposed to individual small point sources as would be seen if the one or more of the light emitting elements were directly visible. This spreading of the light over the aperture area reduces or eliminates hazards from direct view of intense solid state point sources. The unpixelated fixture output is relatively uniform across the apparent output area of the fixture, e.g. across the optical aperture 47 of the cavity 41. Typically, the combined light output exhibits a relatively low maximum-to-minimum intensity ratio across the area of the virtual source formed by the aperture 47. In the example, the combined light output exhibits a maximum-to-minimum ratio of 2 to 1 (2:1) or less over substantially the entire area of the aperture.

In the examples, the apparatus 40 is shown emitting the combined radiant energy downward through the aperture 47, for convenience. However, the apparatus 40 may be oriented in any desired direction to perform a desired application function, for example to provide visible luminance to persons in a particular direction or location with respect to the fixture or to illuminate a different surface such as a wall, floor or table top. Also, the optical integrating cavity 41 may have more than one aperture 47, for example, oriented to allow emission of integrated light in two or more different directions or regions.

The apparatus 40 also includes solid state light emission sources of radiant energy of different wavelengths. In this example, the solid state sources are LEDs 49, two of which are visible in the illustrated cross-section. The LEDs 49 supply radiant energy into the interior of the optical integrating cavity 41. As shown, the points of emission into the interior of the optical integrating cavity direct light toward a reflective surface of the cavity 41 and therefore are not directly visible through the aperture 47. Direct emissions from the LEDs 49 toward the diffusely reflective inner surface of the dome 43 causes the generated light from the sources to diffusely reflect at least once within the cavity 41 before emission in the combined light passing out of the cavity through the aperture 47 as the virtual source output of the fixture. At least the two illustrated LEDs emit radiant energy of different wavelengths, e.g. Red (R) and Green (G). Additional-LEDs of the same or different colors may be provided. The cavity 41 effectively integrates the light energy of different wavelengths, so that the integrated or combined radiant energy emitted through the aperture 47 includes the radiant energy of all the various wavelengths in relative amounts substantially corresponding to the relative amounts of input into the cavity 41 from the respective LEDs 49.

The source LEDs 49 can include LEDs of any color or wavelength. Typically, an array of LEDs for a visible light application includes at least red, green, and blue LEDs. The integrating or mixing capability of the cavity 41 serves to project light of any color, including white light, by adjusting the intensity of the various sources coupled to the cavity. Hence, it is possible to control color rendering index (CRI), as well as color temperature. The system 40 works with the totality of light output from a family of LEDs 49. However, to provide color adjustment or variability, it is not necessary to control the output of individual LEDs, except as they contribute to the totality. For example, it is not necessary to modulate the LED outputs. Simple current control will suffice if the application does not warrant the more complex modulation control. Also, the distribution pattern of the individual LEDs and their emission points into the cavity are not significant. The LEDs 49 can be arranged in any manner to supply radiant energy within the cavity, although it is preferred that direct view of the LEDs from outside the fixture is minimized or avoided.

In this example, light outputs of the LED sources 49 are coupled directly to openings at points on the interior of the cavity 41, to emit radiant energy directly into the interior of the optical integrating cavity. The LEDs may be located to emit light at points on the interior wall of the element 43, although preferably such points would still be in regions out of the direct line of sight through the aperture 47. For ease of construction, however, the openings for the LEDs 49 are formed through the cover plate 45. On the plate 45, the openings/LEDs may be at any convenient locations. From such locations, all or substantially all of the direct emissions from the LEDs 49 impact on the internal surface of the dome 43 and are diffusely reflected.

The apparatus 40 also includes a control circuit 51 coupled to the LEDs 49 for establishing output amount of radiant energy of each of the LED sources. The control circuit 51 typically includes a power supply circuit coupled to a source, shown as an AC power source 53. The control circuit 51 also includes an appropriate number of LED driver circuits for controlling the power applied to each of the different color LEDs 49 and thus the amount of radiant energy supplied to the cavity 41 for each different wavelength. It is possible that the power could be modulated to control respective light amounts output by the LEDs, however, in the examples, LED outputs are controlled by controlling the amount of power supplied to drive respective LEDs and thus the respective intensities. Such control of the emissions of the sources sets a spectral characteristic of the combined radiant energy emitted through the aperture 47 of the optical integrating cavity. The control circuit 51 may be responsive to a number of different control input signals, for example, to one or more user inputs as shown by the arrow in FIG. 6. Although not shown in this simple example, feedback may also be provided. Specific examples of the control circuitry are discussed in more detail later. The control circuit 51 implements a time monitoring function, as will be discussed, later.

The aperture 47 may serve as the system output, directing integrated color light of relatively uniform intensity distribution to a desired area or region to be illuminated. Although not shown in this example, the aperture 47 may have a grate, lens or diffuser (e.g. a holographic element) to help distribute the output light and/or to close the aperture against entry of moisture of debris. For some applications, the system 40 includes an additional processing element to distribute and/or limit the light output to a desired field of illumination.

For example, the light/integrating energy distribution apparatus may also utilize one or more deflectors 55 having a reflective inner surface, to efficiently direct most of the light emerging from a light source into a relatively narrow field of view. Although other deflector shapes may be used, the example shows a conical deflection. A small opening at a proximal end of the deflector 55 is coupled to the aperture 47 of the optical integrating cavity 41. The deflector 55 has a larger opening 57 at a distal end thereof. The angle and distal opening of the conical deflector 55 define an angular field of radiant energy emission from the apparatus 40. Although not shown, the large opening of the deflector may be covered with a transparent plate or lens, or covered with a grating, to prevent entry of dirt or debris through the cone into the system and/or to further process the output radiant energy.

The conical deflector may have a variety of different shapes, depending on the particular lighting application. In the example, where cavity 41 is hemispherical, the cross-section of the conical deflector is typically circular. However, the deflector may be somewhat oval in shape. In applications using a semi-cylindrical cavity, the deflector may be elongated or even rectangular in cross-section. The shape of the aperture 47 also may vary, but will typically match the shape of the small end opening of the deflector 55. Hence, in the example, the aperture 47 would be circular. However, for a device with a semi-cylindrical cavity and a deflector with a rectangular cross-section, the aperture may be rectangular.

The deflector 55 comprises a reflective interior surface 59 between the distal end and the proximal end. In some examples, at least a substantial portion of the reflective interior surface 59 of the conical deflector exhibits specular reflectivity with respect to the integrated radiant energy. As discussed in U.S. Pat. No. 6,007,225, for some applications, it may be desirable to construct the deflector 55 so that at least some portion(s) of the inner surface 59 exhibit diffuse reflectivity or exhibit a different degree of specular reflectivity (e.g., quasi-secular), so as to tailor the performance of the deflector 55 to the particular application. For other applications, it may also be desirable for the entire interior surface 59 of the deflector 55 to have a diffuse reflective characteristic. In such cases, the deflector 55 may be constructed using materials similar to those taught above for construction of the optical integrating cavity 41.

In the illustrated example, the large distal opening 57 of the deflector 55 is roughly the same size as the cavity 41. In some applications, this size relationship may be convenient for construction purposes. However, a direct relationship in size of the distal end of the deflector and the cavity is not required. The large end of the deflector may be larger or smaller than the cavity structure. As a practical matter, the size of the cavity is optimized to provide the integration or combination of light colors from the desired number of LED sources 49. The size, angle and shape of the deflector determine the area that will be illuminated by the combined or integrated light emitted from the cavity 41 via the aperture 47.

In the example, each solid state source of radiant energy of a particular wavelength comprises one or more light emitting diodes (LEDs) 39. Within the chamber 41, it is possible to process light received from any desirable number of such LEDs 39. Hence, in several examples including that of FIG. 6, the sources may comprise one or more LEDs for emitting light of a first color, and one or more LEDs for emitting light of a second color, wherein the second color is different from the first color. In a similar fashion, the apparatus may include additional sources comprising one or more LEDs of a third color, a fourth color, etc. TO achieve the highest color rendering index (CRI), the LED array may include LEDs of various wavelengths that cover virtually the entire visible spectrum. Examples with additional sources of substantially white light are discussed later.

Additional information regarding the structure, arrangement and applications of the solid state lighting type lamp or fixture and control/driver circuitry thereof may be found in U.S. Pat. No. 6,995,355 entitled “Optical integrating chamber lighting using multiple color sources” to Rains, Jr. et al.

The inventive devices have numerous applications, and the output intensity and spectral characteristic may be tailored and/or adjusted to suit the particular application. For example, the intensity of the integrated radiant energy emitted through the aperture forming the virtual source may be at a level for use in a lumination application or at a level sufficient for a task lighting application or other type of general lighting application. A number of other control circuit features also may be implemented. For example, the control may maintain a set color characteristic in response to color and/or intensity feedback from a sensor. The control circuitry may also include a temperature sensor. In such an example, the logic circuitry is also responsive to the sensed temperature, e.g. to reduce intensity of the source outputs to compensate for temperature increases. The control circuitry may include a user interface device or receive signals from a separate user interface device, for manually setting the desired spectral characteristic of the system output. For example, an integrated user interface might include one or more variable resistors or one or more dip switches directly connected into the control circuitry, to allow a user to define or select the desired color distribution and/or intensity.

Automatic controls also are envisioned. For example, the control circuitry may include a data interface coupled to the logic circuitry, for receiving data defining the desired intensity and/or color distribution. Such an interface would allow input of control data from a separate or even remote device, such as a remote control module, a personal computer, a personal digital assistant (PDA) or the like. A number of the systems 40, with such data interfaces, may be controlled from a common central location or device.

The control may be somewhat static, e.g. set the desired color reference index or desired color temperature and the overall intensity, and leave the device set-up in that manner for an indefinite period. The system 40 also may be controlled dynamically, for example, to vary the output color in a controlled perceptible way over time, so as to provide special effects lighting. Where a number of the devices are arranged in a large two-dimensional array, dynamic control of color and intensity of each unit could even provide a video display capability, for example, for use as a “Jumbo Tron” view screen in a stadium or the like. In product lighting or in personnel lighting (for studio or theater work), the lighting can be adjusted for each product or person that is illuminated. Also, such light settings are easily recorded and reused at a later time or even at a different location using a different but generally similar system.

As in the earlier examples, the system 40 is configured to monitor actual time of operation. The operation time monitoring may be implemented in a number of different ways, as mentioned earlier. However, in this example, one or more time meter functions are implemented by a program 23₄ running on a controller that forms the intelligence of the control circuit 51. In its simplest form, the meter program 23₄ would simply count operation time or connect time (age) and provide a mechanism by which the time data could be retrieved from non-volatile storage. In the example, the controller within the circuit 51 is itself always on and operational, whenever power is available from the source 53. Hence, the meter program 23₄ enables the controller to monitor system age based on time connected to power (T_{A}) and time of lighting operation (T_{O}). In a later example including a sensor for feedback control, the programming also offers a more comprehensive detection of performance, in which case the controller may declare a failure when the system 40 no longer operates in accord with some acceptable standard or criteria of performance, e.g. when the system 40 can no longer produce light of adequate intensity or spectral characteristic.

TO appreciate the features and examples of the control circuitry outlined above, it may be helpful to consider a specific example with reference to an appropriate diagram. FIG. 7 is a block diagram of exemplary circuitry for the SSL type light sources and associated control circuit, providing digital programmable control, which may be utilized with a light integrating fixture and perform operation time monitoring of the type described above. In this circuit example, the solid state sources of the radiant energy of the various types take the form of an LED array 111. Arrays of one, two or more colors may be used. The illustrated array 111 comprises two or more LEDs of each of the three primary colors, red green and blue, represented by LED blocks 113, 115 and 117. For example, the array may comprise six red LEDs 113, three green LEDs 115 and three blue LEDs 117.

The LED array 111 in this example also includes a number of additional or “other” LEDs 119. There are several types of additional LEDs that are of particular interest in the present discussion. One type of additional LED provides one or more additional wavelengths of radiant energy for integration within the chamber. The additional wavelengths may be in the visible portion of the light spectrum, to allow a greater degree of color adjustment. Alternatively, the additional wavelength LEDs may provide energy in one or more wavelengths outside the visible spectrum, for example, in the infrared (IR) range or the ultraviolet (UV) range.

The second type of additional LED that may be included in the system is a sleeper LED. Some LEDs would be active, whereas the sleepers would be inactive, at least during initial operation. Using the circuitry of FIG. 7 as an example, the Red LEDs 113, Green LEDs 115 and Blue LEDs 117 might normally be active. The LEDs 119 would be sleeper LEDs, typically including one or more LEDs of each color used in the particular system.

The third type of other LED of interest is a white LED. The entire array 111 may consist of white LEDs of one, two or more color temperatures. For white lighting applications using primary color LEDs (e.g. RGB LEDs), one or more white LEDs provide increased intensity; and the primary color LEDs then provide light for color adjustment and/or correction.

The electrical components shown in FIG. 7 also include a LED control system 120. The system 120 includes driver circuits for the various LEDs and a microcontroller 129. The driver circuits supply electrical current to the respective LEDs 113 to 119 to cause the LEDs to emit light. The driver circuit 121 drives the Red LEDs 113, the driver circuit 123 drives the green LEDs 115, and the driver circuit 125 drives the Blue LEDs 117. In a similar fashion, when active, the driver circuit 127 provides electrical- current to the other LEDs 119. If the other LEDs provide another color of light, and are connected in series, there may be a single driver circuit 127. If the LEDs are sleepers, it may be desirable to provide a separate driver circuit 127 for each of the LEDs 119 or at least for each set of LEDs of a different color.

The LED control 120 may implement any of a variety of different approaches to controlling the light outputs of the LEDs, such as pulse width modulation (PWM) or pulse amplitude modulation (PAM). In the example, the intensity of the emitted light of a given LED is proportional to the level of current supplied by the respective driver circuit. The current output of each driver circuit is controlled by the higher level logic of the system. In this digital control example, that logic is implemented by a programmable microcontroller 129, although those skilled in the art will recognize that the logic could take other forms, such as discrete logic components, an application specific integrated circuit (ASIC), etc. Although not separately shown, digital to analog converters (DACs) may be utilized to convert control data outputs from the microcontroller 129 to analog control signal levels for control of the LED driver circuits.

The LED driver circuits and the microcontroller 129 receive power from a power supply 131, which is connected to an appropriate power source (not separately shown). For most task-lighting applications and the like, the power source will be an AC line current source, however, some applications may utilize DC power from a battery or the like. The power supply 129 converts the voltage and current from the source to the levels needed by the driver circuits 121-127 and the microcontroller 129.

A programmable microcontroller typically includes or has coupled thereto random-access memory (RAM) for storing data and read-only memory (ROM) and/or electrically erasable read only memory (EEROM) for storing control programming and any pre-defined operational parameters, such as pre-established light ‘recipes’ or ‘routines.’ The microcontroller 129 itself comprises registers and other components for implementing a central processing unit (CPU) and possibly an associated arithmetic logic unit. The CPU implements one or more programs to process data in the desired manner and thereby generates desired control outputs.

The microcontroller 129 is programmed to control the LED driver circuits 121-127 to set the respective drive currents and thus the individual output intensities of the LEDs to desired levels, so that the combined light emitted from the aperture of the cavity has a desired spectral characteristic and a desired overall intensity. The microcontroller 129 may be programmed to essentially establish and maintain or preset a desired ‘recipe’ or mixture of the available wavelengths provided by the LEDs used in the particular system. Alternatively, the microcontroller 129 may implement an algorithm to translate input settings into appropriate drive control settings. For some applications, the microcontroller 129 may work through a number of settings over a period of time in a manner defined by a dynamic routine. The microcontroller 129 receives control inputs or retrieves a stored routine specifying the particular ‘recipe’ or mixture, as will be discussed below. To insure that the desired mixture is maintained, the microcontroller receives a color feedback signal from an appropriate color sensor. The same sensor or another light sensor (not separately shown) may also provide feedback as to the overall intensity of the combined light. The microcontroller 129 may also be responsive to a feedback signal from a temperature sensor, for example, in or near the optical integrating cavity.

The electrical system will also include one or more control inputs 133 for inputting information instructing the microcontroller 129 as to the desired operational settings. A number of different types of inputs may be used and several alternatives are illustrated for convenience. A given installation may include a selected one or more of the illustrated control input mechanisms.

As one example, user inputs may take the form of a number of potentiometers 135. The number would typically correspond to the number of different light wavelengths provided by the particular LED array 111. The potentiometers 135 typically connect through one or more analog to digital conversion interfaces provided by the microcontroller 129 (or in associated circuitry). To set the parameters for the integrated light output, the user adjusts the potentiometers 135 to set the intensity for each color. The microcontroller 129 senses the input settings and controls the LED driver circuits accordingly, to set corresponding intensity levels for the LEDs providing the light of the various wavelengths.

Another user input implementation might utilize one or more dip switches 137. For example, there might be a series of such switches to input a code corresponding to one of a number of recipes or to a stored dynamic routine. The memory used by the microcontroller 129 would store the necessary intensity levels for the different color LEDs in the array 111 for each recipe and/or for the sequence of recipes that make up a routine. Based on the input code, the microcontroller 129 retrieves the appropriate recipe from memory. Then, the microcontroller 129 controls the LED driver circuits 121-127 accordingly, to set corresponding intensity levels for the LEDs 113-119 providing the light of the various wavelengths.

As an alternative or in addition to the user input in the form of potentiometers 135 or dip switches 137, the microcontroller 129 may be responsive to control data supplied from a separate source or a remote source. For that purpose, some versions of the system will include one or more communication interfaces. One example of a general class of such interfaces is a wired interface 139. One type of wired interface typically enables communications to and/or from a personal computer or the like, typically within the premises in which the fixture operates. Examples of such local wired interfaces include USB, RS-232, and wire-type local area network (LAN) interfaces. Other wired interfaces, such as appropriate modems, might enable cable or telephone line communications with a remote computer, typically outside the premises. Other examples of data interfaces provide wireless communications, as represented by the interface 141 in the drawing. Wireless interfaces, for example, use radio frequency (RF) or infrared (IR) links. The wireless communications may be local on-premises communications, analogous to a wireless local area network (WLAN). Alternatively, the wireless communications may enable communication with a remote device outside the premises, using wireless links to a wide area network.

As noted above, the electrical components may also include one or more feedback sensors 143, to provide system performance measurements as feedback signals to the control logic, implemented in this example by the microcontroller 129. A variety of different sensors may be used, alone or in combination, for different applications. In the illustrated examples, the set 143 of feedback sensors includes a color sensor 145 and a temperature sensor 147. Although not shown, other sensors, such as an overall intensity sensor may be used. The sensors are positioned in or around the system to measure the appropriate physical condition, e.g. temperature, color, intensity, etc.

The color sensor 145, for example, is coupled to detect color distribution in the integrated radiant energy. The color sensor may be coupled to sense energy within the optical integrating cavity, within the deflector (if provided) or at a point in the field illuminated by the particular system. Various examples of appropriate color sensors are known. For example, the color sensor may be a digital compatible sensor, of the type sold by TAOS, Inc. Such a sensor is controlled by the microcontroller 129 to selectively provide a measurement of total intensity, as well as measurements of primary colors (e.g. of red, green and blue intensity). Another suitable sensor might use the quadrant light detector disclosed in U.S. Pat. No. 5,877,490, with appropriate color separation on the various light detector elements (see U.S. Pat. No. 5,914,487 for discussion of the color analysis).

The associated logic circuitry, responsive to the detected color distribution, controls the output intensity of the various LEDs 113 to 119, so as to provide a desired color distribution in the integrated radiant energy, in accord with appropriate settings. In an example using sleeper LEDs, the logic circuitry is responsive to the detected color distribution to selectively activate the inactive light emitting diodes as needed, to maintain the desired color distribution in the integrated radiant energy. The color sensor measures the color of the integrated radiant energy produced by the system and provides a color measurement signal to the microcontroller 129. If using the TAOS, Inc. color sensor, for example, the signal is a digital pulse signal derived from a color to frequency conversion, in which the pulse frequency corresponds to the measured intensity.

The temperature sensor 147 may be a simple thermoelectric transducer with an associated analog to digital converter, or a variety of other temperature detectors may be used. The temperature sensor is positioned on or inside of the fixture, typically at a point that is near the LEDs or other sources that produce most of the system heat. The temperature sensor 147 provides a signal representing the measured temperature to the microcontroller 129. The system logic, here implemented by the microcontroller 129, can adjust intensity of one or more of the LEDs in response to the sensed temperature, e.g. to reduce intensity of the source outputs to compensate for temperature increases. The program of the microcontroller 129, however, would typically manipulate the intensities of the various LEDs so as to maintain the desired color balance between the various wavelengths of light used in the system, even though it may vary the overall intensity with temperature. For example, if temperature is increasing due to increased drive current to the active LEDs (with increased age or heat), the controller may deactivate one or more of those LEDs and activate a corresponding number of the sleepers, since the newly activated sleeper(s) will provide similar output in response to lower current and thus produce less heat.

Again, the system includes means to monitor time of system operation. Separate hardware could be provided, however, in this example, the monitoring is performed at least in part by the microcontroller 129. Relevant operations of the microcontroller are controlled by a program or program module/subroutine 130. The program may reside in storage in the microcontroller or in other storage (not shown). In this example, the microcontroller itself is ON whenever the system is connected power. The program 130 causes the microcontroller 129 to count connect time T_{A} whenever the microcontroller 129 is operational, that is to say, whenever the system 131 is receiving power from the supply 131.

The program 130 can be written to enable the microcontroller 129 to detect the ON state of the LEDs in several different ways. For example, the program might cause the microcontroller 129 to count time of lamp operation in response to the state of its settings for the LED drivers (whenever the microcontroller 129 instructs one or more of the drivers 121-127 to apply sufficient power to turn-ON LEDs to generate light). Alternatively, the program might cause the microcontroller 129 to count time of lamp operation in response to light detection as indicated by a feedback signal from the color sensor 145 or from an intensity sensor.

The system includes a non-volatile random access memory (NVRAM) 132, which may be a separate circuit element or an element within the microcontroller 129. The NVRAM 132 provides storage for the data regarding the measured time of operation parameters, in this case age or time T_{A} of system connection to power through supply circuit 131 as well as time T_{O} of light operation or output (light-ON time).

In this implementation, the system also includes a display 134, for providing information related to the monitoring function. The display may be within the fixture, at a wall mounted control element or implemented in some other user interface element. In the example, the display 134 includes time readout display 136 of an appropriate number of digits, e.g. three digits for display of time in thousand hour (Kilo—Hour) increments, essentially to provide an hour meter type display function related to the time T_{O} that the system outputs light. Although not shown, display could also be provided for the total system connect time T_{A}. The program 130 causes the microcontroller 129 to monitor system operations in such a manner that the microcontroller detects at least some types of system failure. Hence, the display 134 also includes an indicator 138 which the microcontroller 129 controls based on system status (e.g. green when the system is operating properly and red in the event of a failure detection by the microcontroller).

In addition or instead of readout via the display 136, the data may also be read from the NVRAM 132 by an appropriate data device, via an output terminal 140. In the example, the terminal 140 allows a technician to read age or time T_{A} of system connection to power. The terminal 140 may also be used to allow readout of either one or both of the time measurements in the event that the microcontroller or other system electronics fail in a manner preventing output via the display.

A more detailed explanation of several of the relevant operations follows.

As can be seen from the discussion of the system electronics of FIG. 7 the microcontroller 129 routinely receives inputs from the sensors 143 as to the operations of the system. The sensor signals can provide information about temperature (from sensor 147) and overall intensity of the combined light within the chamber (from selective operations of the sensor 145). In an implementation using multiple primary color LEDs (e.g. RGB LEDs), the color sensor 145 can also be controlled to detect color characteristics of the combined light. In normal operations, the microcontroller 129 uses these sensor input signals as feedback to control further system operations, typically to achieve and maintain desired settings of intensity and/or spectral characteristic of the combined light. Over time, if performance degrades with age of the initially active LEDs 113-117, the microcontroller 129 can activate sleeper LEDs (from the group of other LEDs 119) as needed to compensate and thereby maintain desired settings for extended periods of time. However, the sensor inputs also provide a mechanism by which the microcontroller 129 can detect certain types of degraded performance conditions and treat those conditions as failures.

As noted, the system electronics shown in FIG. 7 also include means to perform time monitoring, e.g. to support the warranty program. In this implementation, the microcontroller runs executable program code 130 for monitoring the system age and the ON state of the LEDs to provide the time counts T_{A} and T_{O}. The microcontroller program 130, for example, may instruct the microcontroller 129 to accumulate or count up system age time T_{A} whenever microcontroller 129 is powered ON (after completion of boot-up). The microcontroller program 130, for example, may instruct the microcontroller 129 to accumulate or count up light operation time T_{O} whenever the LED controller 120 is applying power to one or more of the LEDs or whenever light output is detected by one of the sensors 143. Whenever the system is ON before a failure has occurred, the program 130 causes the microcontroller 129 to perform a counting function, similar to the counting discussed above. The microcontroller 129 has (or has access to) the non-volatile random access memory (NVRAM) 132, and the program 130 causes the microcontroller 129 to continuously update the connect-time and ON-time counts and store the updated time count values in the NVRAM 132.

The counting functions may be implemented using a system clock (not shown), one or more divider functions to divide the clock down to a frequency or frequencies corresponding to desired time units for T_{A} and T_{O}, and counter functions for T_{A} and T_{O} implemented using the registers of the microcontroller 129. Although the program 130 could implement a down-count operation, in the example, the program causes the microcontroller 129 to count up the time of operation. The counting may be implemented in any convenient units. However, in the example, the most significant digits of the count value T_{A} stored in the NVRAM 132 correspond to thousand hour (Kilo—Hour) increments, for use in driving the hour meter display 136. The connect-time value may correspond to Kilo-Hours or years, or any other convenient time unit.

In this way, the microcontroller 129 performs the clock counting functions to count both system age based on time connected to power and hours of operation of the system based on actual light generation. As in the earlier examples, if the system fails entirely, the time data T_{A} and T_{O} can be read from the non-volatile RAM, in this case via connection of a data device to the terminal 140. If the microcontroller, NVRAM and display are operational, the operation time information T_{O} may be read from the thousand hour digits 136 of the display 136.

However, if the microcontroller 129 detects a degraded performance condition sufficient to consider it a failure, it can stop at least the T_{O} clock counting function (and possibly the T_{A} clock counting function) in response thereto so that the operation time data in the NVRAM 132 provides an indication of the total operation time up to the failure. The microcontroller 129 may provide a failure alert via indicator 132, and the microcontroller 129 uses the most significant digits in of the time count data to drive the Kilo-Hour display 136 to show the hours of light output operation in thousand hour increments, in order to inform a person of the detected failure event and the time of actual lighting operation.

There are a variety of ways that the microcontroller 129 may detect a failure of the system from the sensed system conditions, that is to say when a characteristic indicated by one or more of the sensing signals from the feedback sensors 143 indicates that system performance does not satisfy some predetermined criteria. It may be helpful to consider a few examples.

In operation, an input from one of the controls 133 instructs the microcontroller 129 to drive the LEDs in the array 111 at levels to achieve a desired color characteristic and output intensity. Normally, if the input settings are within the capability of the system, the microcontroller 129 will drive the LEDs 113-117 accordingly, and if needed, will activate sleepers 119 as outlined above. The program 130 can control operation of the microcontroller 129 so that an inability to achieve operation in accord with (or within some range of) the input settings, for some period of time, indicates a failure. For example, if sleepers are already active, and the system can not achieve a set intensity (within a set percentage of the input intensity) for more than some set period (1 minute, or 1 hour, or 1 day, etc.), then the microcontroller 129 can treat that event as a detected failure condition. Such a condition may occur with age of the LEDs or because one or more LEDs or LED strings have failed entirely. In a similar fashion, the microcontroller 129 may declare a failure upon detection that the system has not been able to achieve a color setting for some set period. Such a condition may occur in a multi-color system when LEDs of one color (but not all colors) deteriorate beyond an acceptable performance that can no longer be compensated with user of sleepers or because one or more LEDs or LED strings of one color have failed entirely. In this way, the program 130 provides an intelligent system monitoring function in combination with the time monitoring functions.

A failure, whether caused by a system outage or deterioration of the LED array as detected by the microcontroller 129 causes the microcontroller to stop at least one of the time counting functions. Assume now that the failure causes the microcontroller to stop counting of the operation time T_{O} and to stop counting of the connect time used for the system age parameter T_{A}. The data in the NVRAM 132 provides data for use in determining whether the system was still covered by the warranty at the time of the failure and possibly for pro-rating any warranty service.

With the ability to track time of both connection to power and actual light output operations, it becomes possible for the manufacturer of the solid state lighting system to offer a number of different types of time-based warranties. The warranty could be based on either one or both of the time measurements. Today, manufacturers offer solid state light emitters are promoting the long projected life of their products in terms of hours of operation. Thus, it may be advantageous to the system manufacturer to offer a warranty tied closely to the hours of operation of the solid state light emitters, that is to say the number of hours they are actually powered so as to emit light. The system connect time or ‘age’ may be used only for analysis of failures. Some of the other electronics, such as the microcontroller may be powered at all times that the system is connected to a power source, which may include considerable amounts of time that the system is not operating to generate a light output. If the other electronics have a sufficient life expectancy, e.g. the same or longer than a reasonable period in which a customer might operate the system to emit light for the rated number of hours of operation of the solid state light emitters, it may be commercially feasible to offer a warranty that is also based on system age or connect time. The manufacturer might offer a split warranty of one period of operation for the solid state light emitters and a different period of connect time for the other system components. In another approach, the manufacturer might offer a combined time warranty, e.g. X hours of light output or Y hours (years) of system age, whichever comes first.

There are a variety of ways in which the data may be used to pro-rate the warranty service, if the failed system was still under warranty. For example, if the maximum age and operation limits (Y, X) have not been exceeded yet, the manufacturer might offer a system replacement at a percentage of the regular cost corresponding to the number of thousands of hours of operation (actual light output) of the failed system. In a simple proportional version of such a warranty, the customer might pay only 10% the cost of a new system, if the old system failed at 10,000 hours; the customer might pay only 50% the cost of a new system, if the old system failed at 50,000 hours; and the customer would pay the entire cost (100%) of a new system, if the old system failed after 100,000 or more hours of operation (or if the age T_{A} exceed the years limit Y). Of course other pro-rating formulas may be used, e.g. with a greater percentage (2, 5, or 10, etc.) associated with each thousand hours of operation or with a lesser percentage associated with each thousand hours of operation (e.g. 0.5% per thousand hours up to 200,000 hours).

As shown by the discussion above regarding the system implementation of FIG. 7, many of the operations described above may be carried out by processing of the system data and/or associated monitoring of system age and/or time of operation via execution of software, firmware, or microcode operating on processors or computers of any type used to provided the functionalities of the microcontroller 129 or possibly some other system controller 133. The code for implementing such operations, such as the program 130, may be in the form of computer or microprocessor instruction in any form (e.g. source code, object code, interpreted code, etc.) stored in or carried by any computer or machine readable medium.

Program aspects of the technology may be thought of a “products,” typically in the form of executable code and/or associated data that is carried on or embodied in a type of machine readable medium. Media include any or all of the memory of computers, processors or the like, or associated modules thereof, such as various semiconductor memories, tape drives, disk drives and the like, which may provide storage at any time for the software programming. All or portions of the software may at times be communicated through the Internet or various other telecommunication networks. Such communications, for example, may enable loading of the software from one computer or processor into appropriate storage in or associated with the microcontroller 129. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software.

Terms regarding computer or machine “readable medium” (or media) as used herein therefore relate to any physical medium or transmission medium that participates in providing instructions or code or data (e.g. license records or license related information) to a processor for execution or processing. Such a medium may take many forms, including but not limited to, non-volatile media and volatile media as well as carrier wave and physical transmission media.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all applications, modifications and variations that fall within the true scope of the present teachings.

What is claimed is:

1. A warranty method for a solid state lighting system, the method comprising:
offering a warranty for the solid state lighting system, based on time of system operation, with sale of the solid state lighting system;
following installation of the solid state lighting system, detecting a parameter of system operation and in response accumulating a measurement of total time of system operation from installation;
upon occurrence of a failure of the solid state lighting system, determining whether or not the accumulated measurement of time of system operation meets a warranty eligibility criteria; and
providing a service with respect to the solid state lighting system, offered under the warranty, upon a determination that the accumulated measurement of time of system operation meets the warranty eligibility criteria.

2. The warranty method of claim 1, further comprising pro-rating the service provided, based on the accumulated measurement of time of system operation.

3. The warranty method of claim 1, wherein the step of detecting a parameter of system operation comprises detecting connection of the system to power sufficient to permit system operation.

4. The warranty method of claim 1, wherein the step of detecting a parameter of system operation comprises detecting a condition indicating light output of a solid state emitter of the lighting system.

5. The warranty method of claim 4, wherein the detected condition indicating light output comprises a state of a system controller for driving the solid state emitter to emit light.

6. The warranty method of claim 4, wherein the detected condition indicating light output comprises a level of a drive signal applied to the solid state emitter sufficient to cause the solid state emitter to emit light.

7. The warranty method of claim 4, wherein the detected condition indicating light output comprises sensed output of light from the solid state emitter.

8. A warranty method for a solid state lighting system, the method comprising:
offering a warranty for the solid state lighting system, based on time of connection to power and operation time of a solid state emitter of the system, with sale of the solid state lighting system;
measuring total time of connection of the solid state lighting system to power;
measuring total time of operation of the system to generate light from the solid state emitter;
upon occurrence of a failure of the solid state lighting system, determining whether or not at least one of the measured total time of connection and the measured total time of operation satisfy warranty eligibility criteria; and
providing a service with respect to the solid state lighting system, offered under the warranty, upon determining that the warranty eligibility criteria are satisfied.

9. The warranty method of claim 8, wherein the service provided is pro-rated based on the measured total time of connection.

10. The warranty method of claim 8, wherein the service provided is pro-rated based on the measured total time of operation.

11. The warranty method of claim 8, wherein the eligibility criteria comprises:
a first maximum limit upon measured total time of connection; and
a second maximum limit upon measured total time of operation.

12. The warranty method of claim 8, wherein the measuring of total time of connection comprises:
detecting connection of the solid state lighting system to power; and
in response, measuring cumulative time of connection to power for the solid state lighting system.

13. The warranty method of claim 12, wherein:
the detecting of connection to power comprises operating a controller of the solid state lighting system whenever the solid state lighting system is connected to power; and
the measuring of the cumulative time of connection comprises measuring cumulative time of operation of the controller.

14. The warranty method of claim 8, wherein the measuring of total time of operation of the system comprises:
monitoring operation of the solid state lighting system to detect whenever the solid state light emitter of the system is operating so as to emit light; and
based on the monitoring of operation, measuring cumulative time of operation of the at least one solid state light emitter of the system.

15. The warranty method of claim 14, wherein the monitoring of the operation of the solid state lighting system to detect whenever the solid state light emitter is operating so as to emit light comprises:
controlling application of a signal for driving the solid state light emitter; and
determining that the solid state light emitter is operating so as to emit light whenever the signal is set to a state expected to drive the solid state light emitter so as to emit light.

16. The warranty method of claim 14, wherein the monitoring of the operation of the solid state lighting system to detect whenever the solid state light emitter is operating so as to emit light comprises:
monitoring a drive signal applied to the solid state light emitter of the system; and
determining that the solid state light emitter of the system is operating so as to emit light whenever the drive signal exhibits a level sufficient to drive the solid state light emitter so as to emit light.

17. The warranty method of claim 14, wherein the monitoring of the operation of the solid state lighting system to detect whenever the solid state light emitter is operating so as to emit light comprises:
sensing for a light output of the solid state lighting system; and
determining that the at least one solid state light emitter of the system is operating so as to emit light whenever the sensing step detects a light output from the solid state lighting system.

18. The warranty method of claim 8, wherein the solid state light emitter comprises a plurality of light emitting diodes.

19. A method of measuring age and operation time of a solid state lighting system, the method comprising steps including:
installing the solid state lighting system so as to be operatively connected to power;
detecting connection of the solid state lighting system to power, and in response, measuring cumulative time of connection to power for the solid state lighting system as a representation of age of the system since time of installation;
storing the measured cumulative time of connection to power for the solid state lighting system;
monitoring operation of the solid state lighting system to detect whenever at least one solid state light emitter of the system is operating so as to emit light;
based on the monitoring of operation, measuring cumulative time of operation of the at least one solid state light emitter of the system; and
storing the measured cumulative time of operation of the at least one solid state light emitter of the system.

20. The method of claim 19, wherein the step of monitoring operation of the solid state lighting system to detect whenever at least one solid state light emitter of the system is operating so as to emit light comprises:
controlling application of a signal for driving the at least one solid state light emitter of the system; and
determining that the at least one solid state light emitter of the system is operating so as to emit light whenever the signal is set to a state expected to drive the at least one solid state light emitter so as to emit light.

21. The method of claim 19, wherein the step of monitoring operation of the solid state lighting system to detect whenever at least one solid state light emitter of the system is operating so as to emit light comprises:
monitoring a drive signal applied to the at least one solid state light emitter of the system; and
determining that the at least one solid state light emitter of the system is operating so as to emit light whenever the drive signal exhibits a level sufficient to drive the at least one solid state light emitter so as to emit light.

22. The method of claim 19, wherein the step of monitoring operation of the solid state lighting system to detect whenever at least one solid state light emitter of the system is operating so as to emit light comprises:
sensing for a light output of the solid state lighting system; and
determining that the at least one solid state light emitter of the system is operating so as to emit light whenever the sensing step detects a light output from the solid state lighting system.

23. The method of claim 19, wherein:
the step of detecting connection of the solid state lighting system to power comprises operating a controller of the solid state lighting system whenever the solid state lighting system is connected to power; and
the step of measuring cumulative time of connection to power comprises measuring cumulative time of operation of the controller as the cumulative measure of time of connection to power for the solid state lighting system.

24. The method of claim 19, further comprising:
reading out the stored cumulative time of connection to power and the stored cumulative time of operation of the at least one solid state emitter, after a failure of the system; and
determining eligibility for a warranty service with respect to the installed solid state lighting system in response to one or more of the read out cumulative times.

25. The method of claim 19, wherein the at least one solid state light emitter comprises a plurality of light emitting diodes.

26. A system, comprising:
a solid state lighting system, comprising:
(1) at least one solid state light emitter; and
(2) a controller for connection to power, for applying a controlled drive signal to operate the at least one solid state light emitter; and
means for:
(A) measuring a cumulative time of connection of the controller to power; and
(B) determining whenever the at least one solid state light emitter is operative to output light, and in response, measuring a cumulative operation time of light output of the at least one solid state light emitter.

27. The system of claim 26, wherein the at least one solid state light emitter comprises a plurality of light emitting diodes.

28. The system of claim 26, further comprising:
an optical integrating cavity;
the optical integrating cavity being coupled to receive light from the at least one solid state light emitter;
the optical integrating cavity having a reflective interior surface of the cavity, at least a portion of the reflective interior surface of the cavity exhibiting at least substantially diffuse reflectivity with regard to the light received from the at least one solid state light emitter; and
an optical aperture for emission of reflected light from the optical integrating cavity.

29. The system of claim 28, wherein the at least one solid state light emitter comprises a plurality of light emitting diodes.

30. The system of claim 26, wherein said means comprises:
a program for execution by a programmable processor of the controller, wherein execution of the program causes the processor to measure cumulative run-time of the processor while the controller is connected to power as the cumulative power connection time and to measure the a cumulative operation time of light output of the at least one solid state light emitter based on time that the processor activates the at least one solid state light emitter; and
a non-volatile memory for receiving from the processor and storing the measured cumulative run-time and the measured cumulative operation time of light output of the at least one solid state light emitter.

31. The system of claim 26, wherein said means comprise:
a detector for sensing power applied from the controller to the at least one solid state light emitter;
a program for execution by a programmable processor of the controller, wherein execution of the program causes the processor to measure cumulative run-time of the processor while the controller is connected to power as the cumulative power connection time and to measure the cumulative operation time of light output of the at least one solid state light emitter in response to a sensing signal from the detector; and
a non-volatile memory for receiving from the processor and storing the measured cumulative run-time and the measured cumulative operation time of light output of the at least one solid state light emitter.

32. The system of claim 26, wherein said means comprise:
a detector for sensing light output from the at least one solid state light emitter;
a program for execution by a programmable processor of the controller, wherein execution of the program causes the processor to measure cumulative run-time of the processor while the controller is connected to power as the cumulative power connection time and to measure the cumulative operation time of light output of the at least one solid state light emitter in response to a sensing signal from the detector; and
a non-volatile memory for receiving from the processor and storing the measured cumulative run-time and the measured cumulative operation time of light output of the at least one solid state light emitter.

33. The system of claim 26, wherein:
the detector senses a characteristic of the light output; and
execution of the program causes the processor to detect a failure if the characteristic sensed by the detector does not satisfy a system performance criteria.

34. The system of claim 26, further comprising a data interface for output of the measured cumulative run-time and the measured cumulative operation time of light output of the at least one solid state light emitter to a data device.

35. The system of claim 26, further comprising a display for visible output of the measured cumulative run-time and the measured cumulative operation time of light output of the at least one solid state light emitter.

36. A program product, comprising a machine-readable medium, and executable programming embodied in the medium, wherein execution of the programming by a processor controlling operation of a solid state lighting system will cause the controller to implement steps comprising:
detecting connection of the solid state lighting system to power, and in response, measuring cumulative time of connection to power for the solid state lighting system as a representation of age of the system since installation of the solid state lighting system;
storing the measured cumulative time of connection to power for the solid state lighting system;
monitoring operation of the solid state lighting system to detect whenever at least one solid state light emitter of the system is operating so as to emit light;
based on the monitoring of operation, measuring cumulative time of operation of the at least one solid state light emitter of the system; and
storing the measured cumulative time of operation of the at least one solid state light emitter of the system.
